(19) United States
(12) Patent Application Publication
(10) Pub. No.: US 2026/0227912 A1
(43) Pub. Date: Aug. 6, 2026

(54) STORAGE SYSTEM WITH DRIVE WRITES PER DAY BASED TIERING

(71) Applicant: Dell Products L.P., Round Rock, TX (US)

(72) Inventors: Sanjib Mallick, Bangalore (IN); Dan Aharoni, Brookline, MA (US)

(21) Appl. No.: 19/044,713

(22) Filed: Feb. 4, 2025

(51) Int. Cl. G06F 3/06

(52) U.S. Cl. CPC G06F 3/0613; G06F 3/0647; G06F 3/067

(57) ABSTRACT

A storage system includes multiple storage tiers implemented based at least in part on a drive writes per day metric, including at least a first storage tier associated with a first value of the drive writes per day metric and a second storage tier associated with a second value of the drive writes per day metric different than the first value of the drive writes per day metric, each of the storage tiers comprising one or more storage drives each having assigned thereto the value of the drive writes per day metric of that storage tier. Data is dynamically moved between the storage tiers of the storage system based at least in part on data access frequency in a manner that places more frequently accessed data on one of the storage tiers having a higher value of the drive writes per day metric than another of the storage tiers.

### FIELD

The field relates generally to information processing systems, and more particularly to storage in information processing systems.

### BACKGROUND

Information processing systems often include distributed storage systems comprising multiple storage nodes. These distributed storage systems may be dynamically reconfigurable under software control in order to adapt the number and type of storage nodes and the corresponding system storage capacity as needed, in an arrangement commonly referred to as a software-defined storage system. For example, in a typical software-defined storage system, storage capacities of multiple distributed storage nodes are pooled together into one or more storage pools. For applications running on a host that utilizes the software-defined storage system, such a storage system provides a logical storage object view to allow a given application to store and access data, without the application being aware that the data is dynamically distributed among different storage nodes. In these and other storage systems, it can be unduly difficult to manage storage drive wear issues without unduly increasing the overall cost of the storage system. For example, conventional approaches can lead to sub-optimal arrangements in terms of storage drive selection and configuration, potentially leading to significant adverse impacts on system cost, performance and resilience.

### SUMMARY

Illustrative embodiments provide techniques for drive writes per day based tiering in a storage system.

Such techniques in some embodiments can provide improved processing of input-output (IO) operations in a software-defined storage system or other type of distributed storage system comprising one or more clusters of storage nodes, although the disclosed techniques are more generally applicable to any type of storage system comprising multiple storage drives. For example, these and other embodiments can significantly improve storage system performance and resilience, as well as storage drive health, and at substantially reduced cost, relative to conventional approaches.

In one embodiment, an apparatus comprises at least one processing device that includes a processor coupled to a memory. The at least one processing device is illustratively configured to implement a plurality of storage tiers in a storage system based at least in part on a drive writes per day metric, including at least a first storage tier associated with a first value of the drive writes per day metric and a second storage tier associated with a second value of the drive writes per day metric different than the first value of the drive writes per day metric, each of the storage tiers comprising one or more storage drives each having assigned thereto the value of the drive writes per day metric of that storage tier. The at least one processing device is further configured to dynamically move data of the storage system between the storage tiers of the storage system based at least in part on data access frequency in a manner that places more frequently accessed data on one of the storage tiers having a higher value of the drive writes per day metric than another of the storage tiers.

The drive writes per day metric for a given one of the storage drives in some embodiments is specified in terms of a numerical value that indicates the number of times that a particular capacity of the given storage drive can be written each day for the length of a designated period of time. Other types of drive write per day metrics can be used in other embodiments.

In some embodiments, the first value of the drive writes per day metric is set to a value that is greater than a drive writes per day value indicated in a manufacturer specification of the one or more storage drives of the first storage tier.

Additionally or alternatively, the second value of the drive writes per day metric in some embodiments is set to a value that is the same as a drive writes per day value indicated in a manufacturer specification of the storage drives of the second storage tier.

Other embodiments can include other arrangements of storage tiers and associated values of the drive writes per day metric.

For example, in some embodiments, the plurality of storage tiers of the storage system include at least one additional storage tier each comprising one or more storage drives having assigned thereto a value of the drive writes per day metric that is different than the first and second values associated with the respective first and second storage tiers.

As another example, each of the storage drives of a given one of the storage tiers in some embodiments is assigned a same value of the drive writes per day metric that is different than a value of the drive writes per day metric indicated in a manufacturer specification of that storage drive of the given storage tier.

In some embodiments, the one or more storage drives of a given one of the storage tiers are each assigned an increased value of the drive writes per day metric that is determined based at least in part on utilization of less than a full capacity of that storage drive. For example, the increased value of the drive writes per day metric may be determined based at least in part on utilization of only a particular portion of the full capacity, such as 50% of the full capacity, which establishes a corresponding particular increased value of the drive writes per day metric. The increased value of the drive writes per day metric in some embodiments is greater than a drive writes per day value indicated in a manufacturer specification of the one or more storage drives of the given storage tier.

The at least one processing device in some embodiments is further configured to implement a preference for utilization of the given storage tier having the increased value of the drive writes per day metric in processing incoming write operations.

Additionally or alternatively, different assigned values of the drive writes per day metric for different ones of the storage tiers are determined in some embodiments based at least in part on respective different write amplification factors. For example, a particular write amplification factor may correspond to utilization of only a particular portion of the full capacity of a storage drive, such as 50% of the full capacity, which establishes a corresponding particular increased value of the drive writes per day metric.

In some embodiments, assignment of different values of the drive writes per day metric for different ones of the storage tiers is controlled at least in part by an operating system tool of the storage system. Such a tool is illustratively implemented by the at least one processing device and in some implementations provides an interface that is made accessible to a storage administrator or other user.

In some embodiments, dynamically moving data of the storage system between the storage tiers of the storage system based at least in part on data access frequency comprises periodically rebalancing data across the storage tiers in a manner that places the most frequently accessed data on the storage tier having a highest value of the drive writes per day metric and places the least frequently accessed data on the storage tier having a lowest value of the drive writes per day metric. Other types of dynamic data movement based on drive writes per day metric values of respective storage tiers can be used.

The at least one processing device in some embodiments is further configured to associate tiering information with respective storage objects of the storage system, where the tiering information includes a tier level indicator and its corresponding drive writes per day value, and a given such storage object is associated with one or more data blocks of the storage system.

The above-noted features of illustrative embodiments are examples only, and should not be viewed as limiting in any way.

These and other illustrative embodiments include, without limitation, apparatus, systems, methods and computer program products comprising processor-readable storage media.

### BRIEF DESCRIPTION OF THE DRAWINGS

FIG. 1 is a block diagram of an information processing system incorporating functionality for drive writes per day based tiering in a distributed storage system in an illustrative embodiment.

FIG. 2 is a flow diagram of a process for drive writes per day based tiering in a distributed storage system in an illustrative embodiment.

FIG. 3 shows another example of an information processing system incorporating functionality for drive writes per day based tiering in a distributed storage system in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources, as well as other types of systems comprising a combination of cloud and edge infrastructure. Numerous different types of enterprise computing and storage systems are also encompassed by the term “information processing system” as that term is broadly used herein.

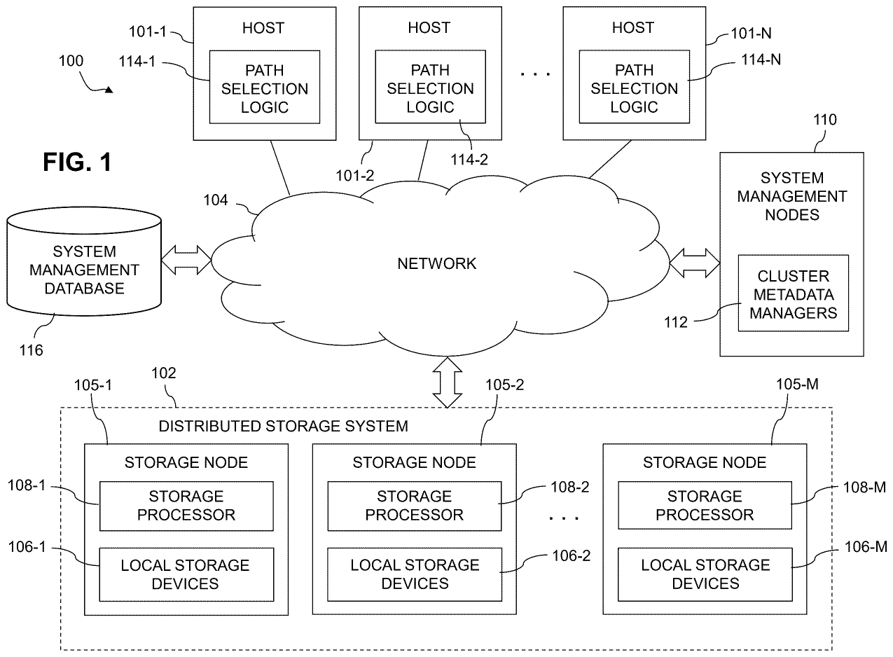

FIG. 1 shows an information processing system 100 configured in accordance with an illustrative embodiment. The information processing system 100 comprises a plurality of hosts 101-1, 101-2, . . . 101-N, collectively referred to herein as hosts 101, and a distributed storage system 102 shared by the hosts 101. The hosts 101 and distributed storage system 102 in this embodiment are configured to communicate with one another via a network 104 that illustratively utilizes protocols such as Transmission Control Protocol (TCP) and Internet Protocol (IP), and is therefore referred to herein as a TCP/IP network, although it is to be appreciated that the network 104 can operate using additional or alternative protocols. In some embodiments, the network 104 comprises a storage area network (SAN) that includes one or more Fibre Channel (FC) switches, Ethernet switches or other types of switch fabrics.

The hosts 101 are also referred to herein as respective “host devices.” It should be noted that terms such as “host” and “host device” as used herein are intended to be broadly construed, so as to encompass, for example, a host system which may comprise multiple distinct devices of various types. A given one of the hosts 101 in some embodiments can therefore comprise, for example, at least one server, as well as a wide variety of additional or alternative types and arrangements of processing devices.

The distributed storage system 102 more particularly comprises a plurality of storage nodes 105-1, 105-2, . . . 105-M, collectively referred to herein as storage nodes 105. The values N and M in this embodiment denote arbitrary integer values that in the figure are illustrated as being greater than or equal to three, although other values such as N=1, N=2, M=1 or M=2 can be used in other embodiments.

The storage nodes 105 collectively form the distributed storage system 102, which is just one possible example of what is generally referred to herein as a “distributed storage system.”

Other distributed storage systems can include different numbers and arrangements of storage nodes, and possibly one or more additional components. For example, as indicated above, a distributed storage system in some embodiments may include only first and second storage nodes, corresponding to an M=2 embodiment. Some embodiments can configure a distributed storage system to include additional components in the form of a system manager implemented using one or more additional nodes.

In some embodiments, the distributed storage system 102 provides a logical address space that is divided among the storage nodes 105, such that different ones of the storage nodes 105 store the data for respective different portions of the logical address space. Accordingly, in these and other similar distributed storage system arrangements, different ones of the storage nodes 105 have responsibility for different portions of the logical address space. For a given logical storage volume, logical blocks of that logical storage volume are illustratively distributed across the storage nodes 105. Additionally or alternatively, logical blocks of one or more logical storage volumes may each be accessible via only a subset of the storage nodes 105. For example, a given one of the storage nodes 105 may store an entire logical storage volume, or multiple entire logical storage volumes.

Other types of distributed storage systems can be used in other embodiments. For example, distributed storage system 102 can comprise multiple distinct storage arrays, such as a production storage array and a backup storage array, possibly deployed at different locations. Each such storage array can comprise one or more of the storage nodes 105, and may be implemented as at least a portion of a cluster of multiple ones of the storage nodes 105.

The distributed storage system 102 in some embodiments comprises multiple clusters, with each such cluster comprising a distinct subset of the storage nodes 105. For example, the distributed storage system 102 can comprise a source cluster and a target cluster, each comprising a different subset of the storage nodes 105, where the source cluster initiates data services, such as replication, migration and/or copying, to be carried out using storage targets of the storage nodes of the second cluster.

Accordingly, in some embodiments, one or more of the storage nodes 105 may each be viewed as comprising at least a portion of a separate storage array or storage cluster with its own logical identifier (e.g., address) space. Alternatively, the storage nodes 105 can be viewed as collectively comprising one or more storage arrays. The term “storage node” as used herein is therefore intended to be broadly construed.

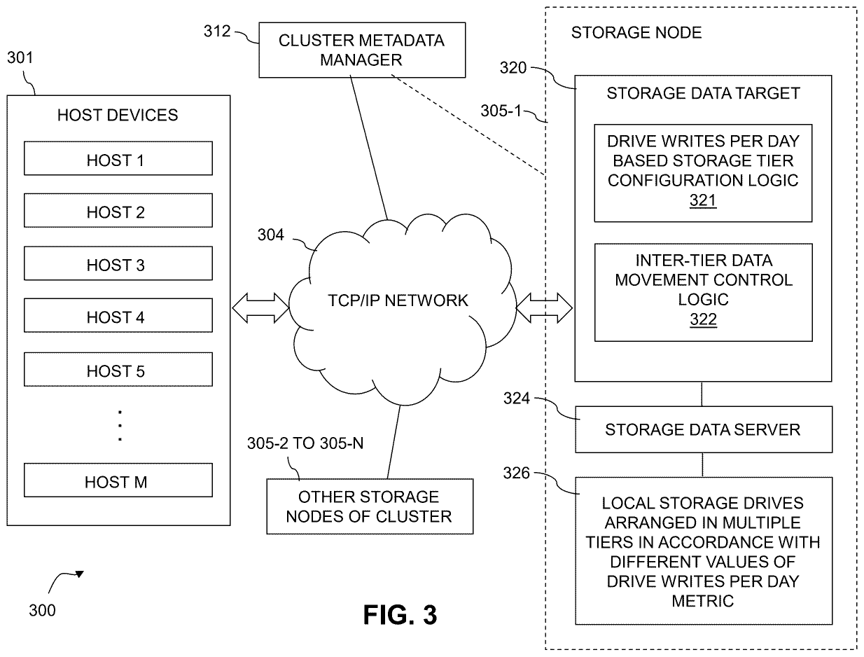

In some embodiments, the distributed storage system 102 comprises a software-defined storage system and the storage nodes 105 comprise respective software-defined storage server nodes of the software-defined storage system, such nodes also being referred to herein as SDS server nodes, where SDS denotes software-defined storage. Accordingly, the number and types of storage nodes 105 can be dynamically expanded or contracted under software control in some embodiments. Examples of such software-defined storage systems will be described in more detail below in conjunction with FIG. 3.

It is to be appreciated, however, that techniques disclosed herein can be implemented in other embodiments in stand-alone storage arrays or other types of storage systems that are not distributed across multiple storage nodes. The disclosed techniques are therefore applicable to a wide variety of different types of storage systems. The distributed storage system 102 is just one illustrative example.

In the distributed storage system 102, each of the storage nodes 105 is illustratively configured to interact with one or more of the hosts 101. The hosts 101 illustratively comprise servers or other types of computers of an enterprise computer system, cloud-based computer system or other arrangement of multiple compute nodes, each associated with one or more system users.

The hosts 101 in some embodiments illustratively provide compute services such as execution of one or more applications on behalf of each of one or more users associated with respective ones of the hosts 101. Such applications illustratively generate input-output (IO) operations that are processed by a corresponding one of the storage nodes 105. The term “input-output” as used herein refers to at least one of input and output. For example, IO operations may comprise write requests and/or read requests directed to logical addresses of a particular logical storage volume of one or more of the storage nodes 105. These and other types of IO operations are also generally referred to herein as IO requests.

The IO operations that are currently being processed in the distributed storage system 102 in some embodiments are referred to herein as outstanding IOs that have been admitted by the storage nodes 105 to further processing within the system 100. The storage nodes 105 are illustratively configured to queue IO operations arriving from one or more of the hosts 101 in one or more sets of IO queues. In some embodiments, each of the storage nodes 105 comprises one or more NVMe targets or other types of targets of the distributed storage system 102, and each such target is configured with a plurality of IO queues. Each such IO queue may have a corresponding TCP connection or other type of network connection with one or more of the hosts 101. Such IO queues and network connections are considered examples of “network resources” as that term is broadly used herein.

The storage nodes 105 illustratively comprise respective processing devices of one or more processing platforms. For example, the storage nodes 105 can each comprise one or more processing devices each having a processor and a memory, possibly implementing virtual machines and/or containers, although numerous other configurations are possible.

The storage nodes 105 can additionally or alternatively be part of cloud infrastructure, such as a cloud-based system implementing Storage-as-a-Service (STaaS) functionality.

The storage nodes 105 may be implemented on a common processing platform, or on separate processing platforms. In the case of separate processing platforms, there may be a single storage node per processing platform or multiple storage nodes per processing platform.

The hosts 101 are illustratively configured to write data to and read data from the distributed storage system 102 comprising storage nodes 105 in accordance with applications executing on those hosts 101 for system users.

The term “user” herein is intended to be broadly construed so as to encompass numerous arrangements of human, hardware, software or firmware entities, as well as combinations of such entities. Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise. Combinations of cloud and edge infrastructure can also be used in implementing a given information processing system to provide services to users.

Communications between the components of system 100 can take place over additional or alternative networks, including a global computer network such as the Internet, a wide area network (WAN), a local area network (LAN), a satellite network, a telephone or cable network, a cellular network such as 4G or 5G cellular network, a wireless network such as a WiFi or WiMAX network, or various portions or combinations of these and other types of networks. The system 100 in some embodiments therefore comprises one or more additional networks other than network 104 each comprising processing devices configured to communicate using TCP, IP and/or other communication protocols.

As a more particular example, some embodiments may utilize one or more high-speed local networks in which associated processing devices communicate with one another utilizing Peripheral Component Interconnect express (PCIe) interface cards of those devices, that support networking protocols such as InfiniBand or Fibre Channel, in addition to or in place of TCP/IP. Numerous alternative networking arrangements are possible in a given embodiment, as will be appreciated by those skilled in the art. Additional examples include remote direct memory access (RDMA) over Converged Ethernet (RoCE) or RDMA over iWARP.

The first storage node 105-1 comprises a plurality of storage devices 106-1 and an associated storage processor 108-1. The storage devices 106-1 illustratively store metadata pages and user data pages associated with one or more storage volumes of the distributed storage system 102. The storage volumes illustratively comprise respective logical units (LUNs) or other types of logical storage volumes (e.g., NVMe namespaces). The storage devices 106-1 in some embodiments more particularly comprise local persistent storage devices of the first storage node 105-1. Such persistent storage devices are local to the first storage node 105-1, but remote from the second storage node 105-2, the storage node 105-M and any other ones of other storage nodes 105.

Each of the other storage nodes 105-2 through 105-M is assumed to be configured in a manner similar to that described above for the first storage node 105-1. Accordingly, by way of example, storage node 105-2 comprises a plurality of storage devices 106-2 and an associated storage processor 108-2, and storage node 105-M comprises a plurality of storage devices 106-M and an associated storage processor 108-M.

As indicated previously, the storage devices 106-2 through 106-M illustratively store metadata pages and user data pages associated with one or more storage volumes of the distributed storage system 102, such as the above-noted LUNs or other types of logical storage volumes. The storage devices 106-2 in some embodiments more particularly comprise local persistent storage devices of the storage node 105-2. Such persistent storage devices are local to the storage node 105-2, but remote from the first storage node 105-1, the storage node 105-M, and any other ones of the storage nodes 105. Similarly, the storage devices 106-M in some embodiments more particularly comprise local persistent storage devices of the storage node 105-M. Such persistent storage devices are local to the storage node 105-M, but remote from the first storage node 105-1, the second storage node 105-2, and any other ones of the storage nodes 105.

The local persistent storage of a given one of the storage nodes 105 illustratively comprises the particular local persistent storage devices that are implemented in or otherwise associated with that storage node.

Such storage devices may be viewed as examples of what are also referred to herein as “storage drives.” The term “storage drive” as used herein is intended to be broadly construed, and should not be viewed as being limited to particular types or configurations of storage drives or other storage devices.

The storage devices 106 of the storage nodes 105 illustratively comprise solid state drives (SSDs). Such SSDs are implemented using non-volatile memory (NVM) devices such as flash memory. Other types of NVM devices that can be used to implement at least a portion of the storage devices 106 include, for example, non-volatile random access memory (NVRAM), phase-change RAM (PC-RAM), magnetic RAM (MRAM), resistive RAM, and spin torque transfer magneto-resistive RAM (STT-MRAM). These and various combinations of multiple different types of NVM devices may also be used. For example, hard disk drives (HDDs) can be used in combination with or in place of SSDs or other types of NVM devices.

However, it is to be appreciated that other types of storage devices can be used in other embodiments. For example, a given storage system as the term is broadly used herein can include a combination of different types of storage devices, as will be described in more detail elsewhere herein. The particular storage devices used in a given storage tier may vary between different embodiments, and it is also possible that multiple distinct storage device types may be used within a single storage tier. The term “storage device” as used herein is intended to be broadly construed, so as to encompass, for example, SSDs, HDDs, flash drives, hybrid drives or other types of storage devices. Such storage devices are examples of local persistent storage devices that may be used to implement at least a portion of the storage devices 106 of the storage nodes 105 of the distributed storage system of FIG. 1.

In some embodiments, the storage nodes 105 collectively provide a distributed storage system, although the storage nodes 105 can be used to implement other types of storage systems in other embodiments. One or more such storage nodes can be associated with at least one storage array. Additional or alternative types of storage products that can be used in implementing a given storage system in illustrative embodiments include software-defined storage, cloud storage and object-based storage. Combinations of multiple ones of these and other storage types can also be used.

As indicated above, the storage nodes 105 in some embodiments comprise respective software-defined storage server nodes of a software-defined storage system, in which the number and types of storage nodes 105 can be dynamically expanded or contracted under software control using software-defined storage techniques.

The term “storage system” as used herein is therefore intended to be broadly construed, and should not be viewed as being limited to certain types of storage systems, such as content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

In some embodiments, communications between the hosts 101 and the storage nodes 105 comprise NVMe commands of an NVMe storage access protocol, for example, as described in the NVM Express Base Specification, Revision 2.0c, October 2022, and its associated NVM Express Command Set Specification and NVM Express TCP Transport Specification, all of which are incorporated by reference herein. Other examples of NVMe storage access protocols that may be utilized in illustrative embodiments disclosed herein include NVMe over Fabrics, also referred to herein as NVMe-oF, and NVMe over TCP, also referred to herein as NVMe/TCP. Other embodiments can utilize other types of storage access protocols, including, for example, NVMe over Fibre Channel, also referred to herein as NVMe/FC.

As another example, communications between the hosts 101 and the storage nodes 105 in some embodiments can be implemented using Small Computer System Interface (SCSI) commands and the Internet SCSI (iSCSI) protocol.

Other types of commands may be used in other embodiments, including commands that are part of a standard command set, or custom commands such as a “vendor unique command” or VU command that is not part of a standard command set. The term “command” as used herein is therefore intended to be broadly construed, so as to encompass, for example, a composite command that comprises a combination of multiple individual commands. Numerous other types, formats and configurations of IO operations can be used in other embodiments, as that term is broadly used herein.

Some embodiments disclosed herein are configured to utilize one or more RAID arrangements to store data across the storage devices 106 in each of one or more of the storage nodes 105 of the distributed storage system 102. Other embodiments can utilize other data protection techniques, such as, for example, Erasure Coding (EC), instead of one or more RAID arrangements.

The RAID arrangement can comprise, for example, a RAID 5 arrangement supporting recovery from a failure of a single one of the plurality of storage devices, a RAID 6 arrangement supporting recovery from simultaneous failure of up to two of the storage devices, or another type of RAID arrangement. For example, some embodiments can utilize RAID arrangements with redundancy higher than two.

The term “RAID arrangement” as used herein is intended to be broadly construed, and should not be viewed as limited to RAID 5, RAID 6 or other parity RAID arrangements. For example, a RAID arrangement in some embodiments can comprise combinations of multiple instances of distinct RAID approaches, such as a mixture of multiple distinct RAID types (e.g., RAID 1 and RAID 6) over the same set of storage devices, or a mixture of multiple stripe sets of different instances of one RAID type (e.g., two separate instances of RAID 5) over the same set of storage devices. Other types of parity RAID techniques and/or non-parity RAID techniques can be used in other embodiments.

Such a RAID arrangement is illustratively established by the storage processors 108 of the respective storage nodes 105. The storage devices 106 in the context of RAID arrangements herein are also referred to as “disks” or “drives.” A given such RAID arrangement may also be referred to in some embodiments herein as a “RAID array.”

The RAID arrangement used in an illustrative embodiment includes a plurality of devices, each illustratively a different physical storage device of the storage devices 106. Multiple such physical storage devices are typically utilized to store data of a given LUN or other logical storage volume in the distributed storage system. For example, data pages or other data blocks of a given LUN or other logical storage volume can be “striped” along with its corresponding parity information across multiple ones of the devices in the RAID arrangement in accordance with RAID 5 or RAID 6 techniques.

A given RAID 5 arrangement defines block-level striping with single distributed parity and provides fault tolerance of a single drive failure, so that the array continues to operate with a single failed drive, irrespective of which drive fails. For example, in a conventional RAID 5 arrangement, each stripe includes multiple data blocks as well as a corresponding p parity block. The p parity blocks are associated with respective row parity information computed using well-known RAID 5 techniques. The data and parity blocks are distributed over the devices to support the above-noted single distributed parity and its associated fault tolerance.

A given RAID 6 arrangement defines block-level striping with double distributed parity and provides fault tolerance of up to two drive failures, so that the array continues to operate with up to two failed drives, irrespective of which two drives fail. For example, in a conventional RAID 6 arrangement, each stripe includes multiple data blocks as well as corresponding p and q parity blocks. The p and q parity blocks are associated with respective row parity information and diagonal parity information computed using well-known RAID 6 techniques. The data and parity blocks are distributed over the devices to collectively provide a diagonal-based configuration for the p and q parity information, so as to support the above-noted double distributed parity and its associated fault tolerance.

In such RAID arrangements, the parity blocks are typically not read unless needed for a rebuild process triggered by one or more storage device failures.

These and other references herein to RAID 5, RAID 6 and other particular RAID arrangements are only examples, and numerous other RAID arrangements can be used in other embodiments. Also, other embodiments can store data across the storage devices 106 of the storage nodes 105 without using RAID arrangements.

In some embodiments, the storage nodes 105 of the distributed storage system of FIG. 1 are connected to each other in a full mesh network, and are collectively managed by a system manager. A given set of local persistent storage devices or other storage devices 106 on a given one of the storage nodes 105 is illustratively implemented in a disk array enclosure (DAE) or other type of storage array enclosure of that storage node. Each of the storage nodes 105 illustratively comprises a central processing unit (CPU) or other type of processor, a memory, a network interface card (NIC) or other type of network interface, and its corresponding storage devices 106, possibly arranged as part of a DAE of the storage node.

In some embodiments, different ones of the storage nodes 105 are associated with the same DAE or other type of storage array enclosure. The system manager is illustratively implemented as a management module or other similar management logic instance, possibly running on one or more of the storage nodes 105, on another storage node and/or on a separate non-storage node of the distributed storage system.

As a more particular non-limiting illustration, the storage nodes 105 in some embodiments are combined together in groups of two or more nodes, with each such group of nodes being coupled to a different DAE comprising multiple drives, and each node in the group of nodes being connected to the DAE and to each drive through a separate connection. The system manager may be running on one of the nodes of a first one of the groups of nodes of the distributed storage system. Again, numerous other arrangements of the storage nodes are possible in a given distributed storage system as disclosed herein.

The system 100 as shown further comprises a plurality of system management nodes 110 that are illustratively configured to provide system management functionality of the type noted above. Such functionality in the present embodiment illustratively further involves utilization of cluster metadata managers 112 and a system management database 116. In some embodiments, at least portions of the system management nodes 110 and their associated cluster metadata managers 112 are distributed over the storage nodes 105. For example, a designated subset of the storage nodes 105 can each be configured to include a corresponding one of the cluster metadata managers 112. Other system management functionality provided by system management nodes 110 can be similarly distributed over a subset of the storage nodes 105. In some embodiments, the cluster metadata managers 112 are implemented in or otherwise associated with respective control plane servers or other types of system management entities.

The system management database 116 stores configuration and operation information of the system 100 and portions thereof are illustratively accessible to various system administrators such as host administrators and storage administrators.

The hosts 101-1, 101-2, . . . 101-N include respective instances of path selection logic 114-1, 114-2, . . . 114-N. Such instances of path selection logic 114 are illustratively utilized in supporting functionality for drive writes per day based tiering in the distributed storage system 102, illustratively through interaction with IO processing logic instances implemented in respective ones of the storage processors 108 of the storage nodes 105, as described in more detail below.

In some embodiments, each of the storage nodes 105 of the distributed storage system 102 is assumed to comprise multiple controllers associated with a corresponding storage target of that storage node, also referred to herein as simply a “target.” Such a target as that term is broadly used herein is illustratively a destination end of one or more paths from one or more of the hosts 101 to the storage node, and may comprise, for example, an NVMe subsystem of the storage node, although other types of targets can be used in other embodiments. It should be noted that different types of targets may be present in NVMe embodiments than are present in other embodiments that use other storage access protocols, such as SCSI embodiments. Accordingly, the types of targets that may be implemented in a given embodiment can vary depending upon the particular storage access protocol being utilized in that embodiment, and/or other factors. Similarly, the types of initiators can vary depending upon the particular storage access protocol, and/or other factors. Again, terms such as “initiator” and “target” as used herein are intended to be broadly construed, and should not be viewed as being limited in any way to particular types of components associated with any particular storage access protocol.

The paths that are selected by instances of path selection logic 114 of the hosts 101 for delivering IO operations from the hosts 101 to the distributed storage system 102 are associated with respective initiator-target pairs, as described in more detail elsewhere herein.

In some embodiments, IO operations are processed in the hosts 101 utilizing their respective instances of path selection logic 114 in the following manner. A given one of the hosts 101 establishes a plurality of paths between at least one initiator of the given host and a plurality of targets of respective storage nodes 105 of the distributed storage system 102. For each of a plurality of IO operations generated in the given host for delivery to the distributed storage system 102, the host selects a path to a particular target, and sends the IO operation to the corresponding storage node over the selected path.

The given host above is an example of what is more generally referred to herein as “at least one processing device” that includes a processor coupled to a memory. The storage nodes 105 of the distributed storage system 102 are also examples of “at least one processing device” as that term is broadly used herein.

It is to be appreciated that path selection as disclosed herein can be performed independently by each of the hosts 101, illustratively utilizing their respective instances of path selection logic 114, as indicated above, with possible involvement of additional or alternative system components.

In some embodiments, the initiator of the given host and the targets of the respective storage nodes 105 are configured to support one or more designated standard storage access protocols, such as an NVMe access protocol or a SCSI access protocol. As more particular examples in the NVMe context, the designated storage access protocol utilized in some embodiments may comprise an NVMe-oF, NVMe/TCP or NVMe/FC access protocol, although a wide variety of additional or alternative storage access protocols can be used in other embodiments.

The hosts 101 can comprise additional or alternative components. For example, in some embodiments, the hosts 101 further comprise respective sets of IO queues and respective multi-path input-output (MPIO) drivers. The MPIO drivers collectively comprise a multi-path layer of the hosts 101. Path selection functionality for delivery of IO operations from the hosts 101 to the distributed storage system 102 is provided in the multi-path layer by respective instances of path selection logic 114 implemented within the MPIO drivers. In some embodiments, the instances of path selection logic 114 are implemented at least in part within the MPIO drivers of the hosts 101.

The MPIO drivers may comprise, for example, otherwise conventional MPIO drivers, such as PowerPath® drivers from Dell Technologies, suitably modified in the manner disclosed herein to provide one or more portions of the disclosed functionality for drive writes per day based tiering. Other types of MPIO drivers from other driver vendors may be suitably modified to incorporate one or more portions of the functionality for drive writes per day based tiering as disclosed herein.

For example, the instances of path selection logic 114 of the respective hosts 101 can be implemented at least in part in respective MPIO drivers of those hosts. Additional or alternative host drivers can be used in other embodiments.

In some embodiments, such instances of path selection logic 114 include or are otherwise associated with respective corresponding instances of host-side IO processing logic that are configured to receive, for a plurality of targets of the distributed storage system 102, corresponding discovery log pages, to extract from the received discovery log pages respective IP addresses for respective ones of the targets, and to control path selection for delivery of IO operations from a corresponding one of the hosts 101 to the targets based at least in part on the extracted IP addresses of the respective targets.

Such host-side IO processing logic can be part of an MPIO layer of the hosts 101, and possibly deployed at least in part within a corresponding instance of path selection logic 114 in the MPIO layer, or can be implemented elsewhere within the hosts 101.

In some embodiments, the hosts 101 comprise respective local caches, implemented using respective memories of those hosts. A given such local cache can be implemented using one or more cache cards. A wide variety of different caching techniques can be used in other embodiments, as will be appreciated by those skilled in the art. Other examples of memories of the respective hosts 101 that may be utilized to provide local caches include one or more memory cards or other memory devices, such as, for example, an NVMe over PCIe cache card, a local flash drive or other type of NVM storage drive, or combinations of these and other host memory devices.

The MPIO drivers are illustratively configured to deliver IO operations selected from their respective sets of IO queues to the distributed storage system 102 via selected ones of multiple paths over the network 104. The sources of the IO operations stored in the sets of IO queues illustratively include respective processes of one or more applications executing on the hosts 101. For example, IO operations can be generated by each of multiple processes of a database application running on one or more of the hosts 101. Such processes issue IO operations for delivery to the distributed storage system 102 over the network 104. Other types of sources of IO operations may be present in a given implementation of system 100.

A given IO operation is therefore illustratively generated by a process of an application running on a given one of the hosts 101, and is queued in one of the IO queues of the given host with other operations generated by other processes of that application, and possibly other processes of other applications.

The paths from the given host to the distributed storage system 102 illustratively comprise paths associated with respective initiator-target pairs, with each initiator comprising, for example, a port of a single-port or multi-port host bus adaptor (HBA) or other initiating entity of the given host and each target comprising a port or other targeted entity corresponding to one or more of the storage devices 106 of the distributed storage system 102. As noted above, the storage devices 106 illustratively comprise LUNs or other types of logical storage devices.

In some embodiments, the paths are associated with respective communication links between the given host and the distributed storage system 102 with each such communication link having a negotiated link speed. For example, in conjunction with registration of a given HBA to a switch of the network 104, the HBA and the switch may negotiate a link speed. The actual link speed that can be achieved in practice in some cases is less than the negotiated link speed, which is a theoretical maximum value.

Negotiated rates of the respective particular initiator and the corresponding target illustratively comprise respective negotiated data rates determined by execution of at least one link negotiation protocol for an associated one of the paths.

In some embodiments, at least a portion of the initiators comprise virtual initiators, such as, for example, respective ones of a plurality of N-Port ID Virtualization (NPIV) initiators associated with one or more Fibre Channel (FC) network connections. Such initiators illustratively utilize NVMe arrangements such as NVMe/FC, although other protocols can be used. Other embodiments can utilize other types of virtual initiators in which multiple network addresses can be supported by a single network interface, such as, for example, multiple media access control (MAC) addresses on a single network interface of an Ethernet network interface card (NIC). Accordingly, in some embodiments, the multiple virtual initiators are identified by respective ones of a plurality of media MAC addresses of a single network interface of a NIC. Such initiators illustratively utilize NVMe arrangements such as NVMe/TCP, although again other protocols can be used.

Accordingly, in some embodiments, multiple virtual initiators are associated with a single HBA of a given one of the hosts 101 but have respective unique identifiers associated therewith.

Additionally or alternatively, different ones of the multiple virtual initiators are illustratively associated with respective different ones of a plurality of virtual machines of the given host that share a single HBA of the given host, or a plurality of logical partitions of the given host that share a single HBA of the given host.

Numerous alternative virtual initiator arrangements are possible, as will be apparent to those skilled in the art. The term “virtual initiator” as used herein is therefore intended to be broadly construed. It is also to be appreciated that other embodiments need not utilize any virtual initiators. References herein to the term “initiators” are intended to be broadly construed, and should therefore be understood to encompass physical initiators, virtual initiators, or combinations of both physical and virtual initiators.

Various scheduling algorithms, load balancing algorithms and/or other types of algorithms can be utilized by the MPIO driver of the given host in delivering IO operations from the IO queues of that host to the distributed storage system 102 over particular paths via the network 104. Each such IO operation is assumed to comprise one or more commands for instructing the distributed storage system 102 to perform particular types of storage-related functions such as reading data from or writing data to particular logical volumes of the distributed storage system 102. Such commands are assumed to have various payload sizes associated therewith, and the payload associated with a given command is referred to herein as its “command payload.”

A command directed by the given host to the distributed storage system 102 is considered an “outstanding” command until such time as its execution is completed in the viewpoint of the given host, at which time it is considered a “completed” command. The commands illustratively comprise respective NVMe commands, although other command formats, such as SCSI command formats, can be used in other embodiments. In the SCSI context, a given such command is illustratively defined by a corresponding command descriptor block (CDB) or similar format construct. The given command can have multiple blocks of payload associated therewith, such as a particular number of 512-byte SCSI blocks or other types of blocks. Other command formats, e.g., Submission Queue Entry (SQE), are utilized in the NVMe context.

In illustrative embodiments to be described below, it is assumed without limitation that the initiators of a plurality of initiator-target pairs comprise respective ports of the given host and that the targets of the plurality of initiator-target pairs comprise respective ports of the distributed storage system 102. The host ports can comprise, for example, ports of single-port HBAs and/or ports of multi-port HBAs, or other types of host ports, including network interface cards (NICs). A wide variety of other types and arrangements of initiators and targets can be used in other embodiments.

Selecting a particular one of multiple available paths for delivery of a selected one of the IO operations from the given host is more generally referred to herein as “path selection.” Path selection as that term is broadly used herein can in some cases involve both selection of a particular IO operation and selection of one of multiple possible paths for accessing a corresponding logical device of the distributed storage system 102. The corresponding logical device illustratively comprises a LUN or other logical storage volume to which the particular IO operation is directed.

It should be noted that paths may be added or deleted between the hosts 101 and the distributed storage system 102 in the system 100. For example, the addition of one or more new paths from the given host to the distributed storage system 102 or the deletion of one or more existing paths from the given host to the distributed storage system 102 may result from respective addition or deletion of at least a portion of the storage devices 106 of the distributed storage system 102.

Addition or deletion of paths can also occur as a result of zoning and masking changes or other types of storage system reconfigurations performed by a storage administrator or other user. Some embodiments are configured to send a predetermined command from the given host to the distributed storage system 102, illustratively utilizing the MPIO driver, to determine if zoning and masking information has been changed. The predetermined command can comprise, for example, a log sense command, a mode sense command, a “vendor unique command” or VU command, or combinations of multiple instances of these or other commands, in an otherwise standardized command format.

In some embodiments, paths are added or deleted in conjunction with addition of a new storage array or deletion of an existing storage array from a storage system that includes multiple storage arrays, possibly in conjunction with configuration of the storage system for at least one of a migration operation and a replication operation.

For example, a storage system may include first and second storage arrays, with data being migrated from the first storage array to the second storage array prior to removing the first storage array from the storage system.

As another example, a storage system may include a production storage array and a recovery storage array, with data being replicated from the production storage array to the recovery storage array so as to be available for data recovery in the event of a failure involving the production storage array.

In these and other situations, path discovery scans may be repeated as needed in order to discover the addition of new paths or the deletion of existing paths.

A given path discovery scan can be performed utilizing known functionality of conventional MPIO drivers, such as PowerPath® drivers.

The path discovery scan in some embodiments may be further configured to identify one or more new LUNs or other logical storage volumes associated with the one or more new paths identified in the path discovery scan. The path discovery scan may comprise, for example, one or more bus scans which are configured to discover the appearance of any new LUNs that have been added to the distributed storage system 102 as well to discover the disappearance of any existing LUNs that have been deleted from the distributed storage system 102.

The MPIO driver of the given host in some embodiments comprises a user-space portion and a kernel-space portion. The kernel-space portion of the MPIO driver may be configured to detect one or more path changes of the type mentioned above, and to instruct the user-space portion of the MPIO driver to run a path discovery scan responsive to the detected path changes. Other divisions of functionality between the user-space portion and the kernel-space portion of the MPIO driver are possible. The user-space portion of the MPIO driver is illustratively associated with an Operating System (OS) kernel of the given host.

For each of one or more new paths identified in the path discovery scan, the given host may be configured to execute a host registration operation for that path. The host registration operation for a given new path illustratively provides notification to the distributed storage system 102 that the given host has discovered the new path.

As indicated previously, the storage nodes 105 of the distributed storage system 102 process IO operations from one or more hosts 101 and in processing those IO operations run various storage application processes that generally involve interaction of that storage node with one or more other ones of the storage nodes.

In the FIG. 1 embodiment, the distributed storage system 102 comprises storage processors 108 and corresponding sets of storage devices 106, and may include additional or alternative components, such as sets of storage-side local caches.

The storage processors 108 illustratively control the processing of IO operations received in the distributed storage system 102 from the hosts 101. For example, the storage processors 108 illustratively manage the processing of read and write commands directed by the MPIO drivers of the hosts 101 to particular ones of the storage devices 106. The storage processors 108 can be implemented as respective storage controllers, directors or other storage system components configured to control storage system operations relating to processing of IO operations. In some embodiments, each of the storage processors 108 has a different one of the above-noted local caches associated therewith, although numerous alternative arrangements are possible.

The storage processors 108 of the storage nodes 105 may include additional modules and other components typically found in conventional implementations of storage processors and storage systems, although such additional modules and other components are omitted from the figure for clarity and simplicity of illustration.

For example, the storage processors 108 in some embodiments can comprise or be otherwise associated with one or more write caches and one or more write cache journals, both also illustratively distributed across the storage nodes 105 of the distributed storage system. It is further assumed in illustrative embodiments that one or more additional journals are provided in the distributed storage system, such as, for example, a metadata update journal and possibly other journals providing other types of journaling functionality for IO operations. Illustrative embodiments disclosed herein are assumed to be configured to perform various destaging processes for write caches and associated journals, and to perform additional or alternative functions in conjunction with processing of IO operations.

The manner in which functionality for drive writes per day based tiering is implemented in system 100 in some embodiments, utilizing hosts 101 and storage nodes 105, will now be described in more detail.

As indicated previously, in software-defined storage system arrangements, and in numerous other storage system contexts, it can be unduly difficult to manage storage device wear issues without unduly increasing the overall cost of the storage system. For example, conventional approaches can lead to sub-optimal arrangements in terms of storage device selection and configuration, potentially leading to significant adverse impacts on system cost, performance and resilience.

Illustrative embodiments disclosed herein provide techniques for drive writes per day based tiering in a storage system. Such techniques in some embodiments can provide improved processing of IO operations in a storage system in a software-defined storage system or other type of distributed storage system comprising one or more clusters of storage nodes, although the disclosed techniques are more generally applicable to any type of storage system comprising multiple storage drives.

For example, these and other embodiments can significantly improve storage system performance and resilience, as well as storage drive health, and at substantially reduced cost, relative to conventional approaches.

In implementing a storage system, the SSDs or other storage drives utilized for data storage typically consume a major share of the storage system cost, in some cases on the order of 70% to 80% of the storage system implementation cost. For enterprise-level users, storage system performance and resilience are the major criteria. Utilizing cheaper drives can reduce the system cost but that adversely impacts performance and resilience through increased frequency of drive health issues. Delivering performance and resilience with lower cost therefore remains an important problem not adequately addressed by conventional approaches.

However, as indicated above, illustrative embodiments disclosed herein provide technical solutions to this problem in software-defined storage systems, distributed storage systems and other types of storage systems.

For example, in some embodiments, drive writes per day based tiering is illustratively implemented in the following manner. It is assumed for purposes of illustration only that the distributed storage system 102 comprises at least one cluster of storage nodes 105. Each such cluster in some embodiments illustratively comprises a different subset of the storage nodes 105, and is managed at least in part by a corresponding one of the cluster metadata managers 112. For example, first and second clusters may comprise respective local and remote clusters of storage nodes in a given implementation of distributed storage system 102. Each such storage node includes one or more storage targets, also referred to herein as simply “targets,” that are utilized in processing IO operations received from one or more of the hosts 101. In some embodiments, such targets can additionally or alternatively be used in processing IO operations associated with one or more data services carried out, for example, between first and second clusters. Numerous other arrangements are possible.

At least one processing device of the system 100, which may comprise, for example, at least one processing device implementing at least a portion of the distributed storage system 102, such as a particular one of the storage nodes 105 via its corresponding one of the storage processors 108, is configured to implement a plurality of storage tiers in the distributed storage system 102, such as in each of one or more of the storage nodes 105 or collectively across multiple ones of the storage nodes 105, based at least in part on a drive writes per day metric, including at least a first storage tier associated with a first value of the drive writes per day metric and a second storage tier associated with a second value of the drive writes per day metric different than the first value of the drive writes per day metric, with each of the storage tiers comprising one or more storage drives each having assigned thereto the value of the drive writes per day metric of that storage tier. The at least one processing device is further configured to dynamically move data of one or more of the storage nodes 105 of the distributed storage system 102 between the storage tiers based at least in part on data access frequency in a manner that places more frequently accessed data on one of the storage tiers having a higher value of the drive writes per day metric than another of the storage tiers.

The drive writes per day metric for a given one of the storage drives in some embodiments is illustratively specified in terms of a numerical value that indicates the number of times that a particular capacity of the given storage drive can be written each day for the length of a designated period of time, although it is to be appreciated that other types of drive write per day metrics can be used in other embodiments.

In some embodiments, the first value of the drive writes per day metric is set to a value that is greater than a drive writes per day value indicated in a manufacturer specification of the one or more storage drives of the first storage tier.

Additionally or alternatively, the second value of the drive writes per day metric in some embodiments is set to a value that is the same as a drive writes per day value indicated in a manufacturer specification of the storage drives of the second storage tier.

The term “value” as used in this context and other similar contexts herein is intended to be broadly construed, and may comprise, for example, a value in a particular range of values that is associated with a particular storage tier in a drive writes per day based storage tiering arrangement as disclosed herein. Accordingly, the storage drives of a given storage tier may have respective assigned values of the drive writes per day metric that each fall within a range of such values associated with the given storage tier. Different ones of the storage drives of the given storage tier may have respective different assigned values within the range of values associated with the given storage tier. References herein to a “value” or an “assigned value” as those terms are broadly used herein can encompass, for example, association of each of the storage devices of the given storage tier with a designation, an indication or another type of information characterizing a range of values and/or an individual value within such a range.

Other embodiments can include other arrangements of storage tiers and associated values of the drive writes per day metric.

For example, in some embodiments, the plurality of storage tiers of the one or more storage nodes 105 of the distributed storage system 102 include at least one additional storage tier each comprising one or more storage drives having assigned thereto a value of the drive writes per day metric that is different than the first and second values associated with the respective first and second storage tiers.

As another example, each of the storage drives of a given one of the storage tiers in some embodiments is assigned a same value of the drive writes per day metric that is different than a value of the drive writes per day metric indicated in a manufacturer specification of that storage drive of the given storage tier.

In some embodiments, the one or more storage drives of a given one of the storage tiers are each assigned an increased value of the drive writes per day metric that is determined based at least in part on utilization of less than a full capacity of that storage drive. For example, the increased value of the drive writes per day metric may be determined based at least in part on utilization of only a particular portion of the full capacity, such as 50% of the full capacity, which establishes a corresponding particular increased value of the drive writes per day metric. The increased value of the drive writes per day metric in some embodiments is greater than a drive writes per day value indicated in a manufacturer specification of the one or more storage drives of the given storage tier.

The at least one processing device in some embodiments is further configured to implement a preference for utilization of the given storage tier having the increased value of the drive writes per day metric in processing incoming write operations.

Additionally or alternatively, different assigned values of the drive writes per day metric for different ones of the storage tiers are determined in some embodiments based at least in part on respective different write amplification factors. For example, a particular write amplification factor may correspond to utilization of only a particular portion of the full capacity of a storage drive, such as 50% of the full capacity, which establishes a corresponding particular increased value of the drive writes per day metric.

In some embodiments, assignment of different values of the drive writes per day metric for different ones of the storage tiers is controlled at least in part by an operating system tool of the distributed storage system 102. Such a tool is illustratively implemented by the at least one processing device and in some implementations provides an interface that is made accessible to a storage administrator or other user of the system 100, possibly via one or more of the system management nodes 110.

In some embodiments, dynamically moving data of the one or more storage nodes 105 of the distributed storage system 102 between the storage tiers based at least in part on data access frequency comprises periodically rebalancing data across the storage tiers in a manner that places the most frequently accessed data on the storage tier having a highest value of the drive writes per day metric and places the least frequently accessed data on the storage tier having a lowest value of the drive writes per day metric. Other types of dynamic data movement based on drive writes per day metric values of respective storage tiers can be used. Such dynamic data movement, like the implementation of the storage tiers themselves, can be separately performed on a per-node basis for each of the storage nodes 105, or can be collectively performed across multiple ones of the storage nodes 105. Terms such as “dynamic data movement” as used herein are therefore intended to be broadly construed.

The at least one processing device in some embodiments is further configured to associate tiering information with respective storage objects of the distributed storage system 102, where the tiering information includes a tier level indicator and its corresponding drive writes per day value, and a given such storage object is associated with one or more data blocks of the distributed storage system 102. For example, such storage objects are illustratively stored in association with the corresponding data blocks, and the tiering information thereof is utilized in conjunction with related data access frequency information to support the above-described dynamic data movement of data between storage tiers.

In some embodiments, the above-noted drive writes per day metric, also denoted in some subsequent description herein as a DWPD metric, is a per storage drive metric, with separate instances of DWPD metric values maintained or otherwise assigned for each of the storage drives of the distributed storage system 102. This metric illustratively indicates the durability and/or expected lifespan of an SSD or other type of storage device, each more generally referred to herein as a “storage drive.”

For example, a 1 terabyte (TB) SSD with a DWPD of 1 would allow a user to write 1 TB of data to the drive every day for the length of a specified warranty period (e.g., 5 years). A 1 TB SSD with a DWPD of 0.3 would similarly allow a user to write 300 gigabytes (GB) each day for the warranty period.

Such DWPD values are illustrative examples of what is more generally referred to herein as a numerical value that indicates the number of times that a particular capacity of the given storage drive can be written each day for the length of a designated period of time, where the designated period of time may be, for example, the above-noted warranty period as specified by the storage drive manufacturer.

Again, other types of drive write per day metrics can be used in other embodiments, and terms such as “drive writes per day metric” and “DWPD metric” as used herein are intended to be broadly construed. For example, a drive writes per day metric as that term is broadly used herein is intended to encompass other types of per-drive durability and/or expected lifespan metrics that utilize different time durations, such as minutes, hours, weeks, months, etc. that can be simply converted to per-day metrics.

An example of an alternative drive writes per day metric of this type is terabytes written (TBW), which denotes the total number of TB that can be written to a storage drive for a specified warranty period or other designated period of time. TBW is considered a type of drive writes per day metric as that term is broadly used herein, as TBW can be directly converted to DWPD by dividing it by the product of (i) the number of days in a year, (ii) the warranty period, and (iii) the storage drive capacity in TB.

Some embodiments utilize an arrangement referred to herein as “short stroking” of an SSD or other storage drive. In such an arrangement, only a portion of the drive's storage capacity is used in the distributed storage system 102, typically to improve performance or reduce wear and tear on the drive. This results in limited storage usage, as instead of using the entire capacity of the SSD, only a fraction of it is utilized, leaving the rest unused or inactive. However, there are performance benefits, such as improved speed. For example, a 0.5 DWPD drive after short stroking can become a 1 DWPD drive and resulting drive performance will be similar to that of a 1 DWPD drive. Also, there are additional benefits in terms of wear leveling, in that by using less of the total capacity of the drive, short stroking can reduce the overall wear of the drive, thereby extending its lifespan.

In some embodiments, short stroking of SSDs or other storage devices is implemented as a feature of the distributed storage system 102, and may be controlled at least in part by the above-noted operating system tool.

An example of utilizing short stroking to increase DWPD values of a given storage drive is as follows, in which different amounts of write amplification (WA) are utilized to determine respective corresponding DWPD values for a quad-level cell (QLC) drive, with the percentages corresponding to respective different amounts of short stroking:

$$100 \% WA = 0.18 DWPD per specification , full capacity$$

$$95 \% WA = 0.2 DWPD$$

$$90 \% WA = 0.3 DWPD$$

$$70 \% WA = 0.5 DWPD$$

$$50 \% WA = 1. DWPD$$

The above is just an example, and the particular values utilized in a given embodiment will depend upon factors such as the drive specification and manufacturer. Also, in other embodiments, DWPD values can be determined without reference to write amplification.

In some embodiments, a given one of the storage nodes 105 of the distributed storage system 102 is configured to utilize only cheaper storage drives with relatively low DWPD values, such as the QLC drive in the above example with a 0.18 DWPD value. However, a certain percentage (X %) of the storage drives in the given storage node are programmed via the above-described short stroking to exhibit higher DWPD values, such as 1 DWPD. Such higher DWPD values are an example of what is more generally referred to herein as DWPD values “assigned to” the corresponding storage drives, where the assignment is intended to be broadly construed and can be accomplished in a wide variety of different ways. For example, 20% of the storage drives in the given storage node (e.g., 2 out of 10 storage drives) are programmed with 1 DWPD values, to provide a first or highest DWPD value storage tier of a multi-tier storage arrangement utilizing DWPD. All or substantially all writes received in the given storage node from applications executing on one or more host devices will be processed using these 1 DWPD drives of the first storage tier of the given storage node.

The rest of the storage drives of the given storage node have lower DWPD values, and occupy one or more lower storage tiers of the multi-tier storage arrangement, with each of the subsets of the storage drives having the same DWPD value being an example of what is more generally referred to herein as a “storage tier” of the given storage node. For example, there can be multiple DWPD tiers, each having one or more storage drives of a particular corresponding DWPD value, such as a 1 DWPD tier, a 0.5 DWPD tier and a 0.18 DWPD tier, or a particular corresponding range of such DWPD values, although it is to be appreciated that other types and arrangements of multiple DWPD tiers can be used.

The other storage nodes 105 of the distributed storage system 102 are each assumed to be configured in a manner similar to that described for the given storage node above, and similar arrangements are utilized in non-distributed storage systems. Also, as indicated previously, the storage tiers associated with the respective different DWPD values can be implemented across multiple ones of the storage nodes 105, such as collectively across all of the storage nodes 105 of the distributed storage system 102.

In some embodiments, each new write is processed using the highest DWPD tier of storage drives configured in the given storage node of the distributed storage system 102. In addition, each written data block illustratively has aging information associated therewith in the distributed storage system 102. The block size can vary based at least in part on the implementation, but in some embodiments is based at least in part on a RAID write size utilized in the storage system backend.

The distributed storage system 102 and/or individual storage nodes 105 thereof in some embodiments are configured to periodically execute a low-priority task to move stale data blocks to lower DWPD tiers. Various definitions of “staleness” can be used. For example, different DWPD tiers can correspond to different ranges of aging information or other staleness measures within the distributed storage system 102.

As a more particular example, data blocks that have not been rewritten in the previous week can be moved from Tier 1 at 1 DWPD to a lower Tier 2 at 0.5 DWPD. Similarly, data blocks that have not been rewritten in the previous month can be moved from Tier 2 at 0.5 DWPD to a lower Tier 3 at 0.18 DWPD. Numerous other arrangements of tiers, DWPD values and staleness-based data movement timing mechanisms can be used in other embodiments.

Some embodiments include storage appliances that are configured to associate tiering information with respective storage objects. For example, a tier object can be introduced that includes tier level and its corresponding DWPD value, and is associated with data blocks in a RAID layer of a storage system.

In some embodiments, a storage administrator or other user can establish or otherwise configure an initial short stroking arrangement, such as 20% of the storage drives in a 1 DWPD first storage tier, 30% of the storage drives in a 0.5 DWPD second storage tier, and the remaining 50% of the storage drives of 0.18 DWPD third storage tier, illustratively via an interface of the type referred to elsewhere herein. Such configurations can also be at least partially automatically implemented in some embodiments. It is assumed in some embodiments that all storage devices of a given tier have the same DWPD value. A modified total raw capacity of the storage system can be determined and advertised based on the initial short stroking arrangement. As indicated above, writes received from host applications are processed using the first or highest DWPD tier. For example, RAID blocks for RAID writes are illustratively selected only from the highest DWPD tier.

Periodic rebalancing is illustratively performed in order to ensure that there is sufficient storage space in the highest DWPD tier in order to accommodate new writes. The term “periodic” as used herein is intended to be broadly construed, and should not be viewed as being limited to particular fixed periods, but is instead intended to encompass variable periods, substantially continuous arrangement, and other arrangements.

Some embodiments track the remaining useful life of the highest tier storage drives, and when a threshold amount of remaining useful life is reached, those drives can be switched with lower-tier drives.

As indicated previously, some embodiments provide significant cost reductions in a storage system, without adverse performance impacts.

For example, assume a 0.18 DWPD QLC SSD with 15.36 TB of storage capacity that is priced between $1.7K and $3.5K. After short stroking to 50%, the drive reduces 50% of capacity but becomes a 1 DWPD drive. A 1 DWPD tri-level cell (TLC) SSD with 7.68 TB storage capacity could cost around $11.5K, illustrating the potential for a significant cost reduction achieved through the DWPD tiering arrangement disclosed herein.

Consider as another example a storage node implementing a two-tier DWPD arrangement with 0.18 DWPD QLC drives, and more particularly 20% 1 DWPD drives and 80% 0.18 DWPD. Without short stroking and with 10 drives per node the cost would be about $35K for a storage capacity of 150 TB. After short stroking of the two drives to 1 DWPD, capacity of those two drives is reduced by 50%, for a total node storage capacity of 150 TB−2*(15 TB*50%)=135 TB. Price per TB for the node is therefore reduced to $35K/135 TB=$0.26K/TB, as compared to the substantially higher cost for a non-tiered arrangement with ten 1 DWPD drives, at about $11.5K*10/7.68 TB=$1.5K/TB.

Illustrative embodiments disclosed herein can provide significant advantages over conventional approaches. Such advantages in some embodiments include substantially reduced storage system cost, as well as optimized storage drive life based on usage, and no reduction in write performance based on utilization of lower-cost storage drives.

For example, illustrative embodiments that are configured to maintain relatively “cold” data in relatively low DWPD tiers can ensure that the active data uses the highest DWPD tier and thereby increases drive life.

Accordingly, illustrative embodiments can provide improved performance, resiliency and drive health, at significantly lower cost than would otherwise be possible.

Additional aspects of some illustrative embodiments will now be described.

Each of one or more of the storage targets of the distributed storage system 102 in some embodiments is configured to operate as a host-storage interface to handle IO operations received in the storage target from one or more of the hosts 101, and possibly also as a data mobility interface to handle IO operations generated as part of one or more data services, such as replication, migration and/or copying, carried out between multiple clusters of the distributed storage system 102. The IO processing loads of the respective storage targets of the distributed storage system 102 therefore illustratively include at least processing of IO operations received in the storage targets from the one or more hosts 101.

In some embodiments, a host receives, for each of multiple storage targets of the distributed storage system 102, corresponding discovery log pages, illustratively from one or more discovery controllers which in some embodiments are implemented on one or more of the multiple targets and/or on at least one different target that is not part of the multiple targets, although other arrangements are possible. In some embodiments, the discovery log pages are illustratively obtained using commands of a storage access protocol, such as an NVMe access protocol, including NVMe-oF or NVMe/TCP, although the disclosed techniques are applicable for use with other storage access protocols, including SCSI and iSCSI access protocols. The term “discovery log page” as used herein is therefore intended to be broadly construed, as illustratively comprising, for example, at least one log page or a suitable portion thereof that includes one or more entries comprising information utilized by the host to discover and connect to the corresponding target, and should not be viewed as being limited to a particular type of log page configured in accordance with a particular storage access protocol.

Additional details regarding NVMe discovery log pages and other aspects of the NVMe standard can be found in, for example, the above-cited NVM Express Base Specification, Revision 2.0c, October 2022, and its associated NVM Express Command Set Specification and NVM Express TCP Transport Specification, although other NVMe implementations can be used.

As mentioned above, each of the storage nodes 105 of the distributed storage system 102 illustratively comprises one or more targets, where each such target is associated with multiple distinct paths from respective HBAs or other initiators of one or more of the hosts 101.

For example, in some embodiments, one or more of the storage nodes 105 each implements at least one target, such as an NVMe target, that is configured to include multiple controllers, such as at least a first controller associated with a first storage pool, and a second controller associated with a second storage pool. The first and second storage pools are illustratively storage pools of the distributed storage system 102, and such storage pools may be distributed across multiple ones of the storage nodes 105. Each of the first and second storage pools is assumed to comprise one or more LUNs or other logical storage volumes.

Although first and second controllers are referred to in conjunction with some embodiments herein, it is to be appreciated that more than two controllers can be implemented in a given target in order to support more than two storage pools.

A given one of the storage nodes 105 illustratively processes IO operations received from one or more of the hosts 101, with different ones of the IO operations being directed by the one or more hosts 101 from one or more initiators of the one or more hosts 101 to different ones of the first and second controllers of the target implemented within the given storage node.

In some embodiments, each of the IO queues configured in the distributed storage system 102 for the given target is associated with a corresponding different TCP connection between the given host and the given target.

The given target may comprise at least one NVMe controller of a particular one of the storage nodes 105 of the distributed storage system 102, although other types of targets can be used.

Terms such as “storage target” and “target” as used herein in the context of a distributed storage system or other type of storage system are intended to be broadly construed. As indicated previously, storage targets in some embodiments are also referred to herein as simply “targets.”

The target in some embodiments more particularly comprises multiple controllers accessible via respective different associations comprising one or more TCP connections between the given host and the given storage node. For example, the target may comprise a plurality of NVMe controllers of an NVMe subsystem of the given storage node.

In some embodiments, an NVMe target illustratively comprises one or more NVMe controllers, each having a set of TCP connections associated with an administrative (“Admin”) queue and one or more IO queues. Each TCP connection illustratively corresponds to a single queue having associated request/response entries. In some embodiments, the TCP connections corresponding to a given Admin queue and a set of one or more IO queues are collectively referred to as a “TCP association.” Typically, a fixed number of IO queues are established, with a corresponding fixed number of TCP connections, in accordance with maximum load requirements of one or more applications that will be directing IO operations to the NVMe target for processing. The IO queues and their corresponding TCP connections are examples of what are more generally referred to herein as “network resources.” Such network resources in some embodiments are illustratively used to receive IO operations directed to targets of a storage system from initiators of one or more host devices. Additional or alternative network resources can be used in other embodiments.

As indicated above, in some embodiments, multiple controllers are part of a single physical controller subsystem of the given storage node. For example, first and second controllers may comprise respective NVMe controllers of an NVMe subsystem of the given storage node. Such an NVMe subsystem is considered an example of what is more generally referred to herein as a “storage target” or “target” of the given storage node. A wide variety of other types and arrangements of storage targets can be used in other embodiments.

The first and second controllers in some embodiments may be viewed as comprising respective “virtual” controllers associated with the single physical controller subsystem of the given storage node.

Additionally or alternatively, the first and second controllers in some embodiments are accessible via respective first and second different associations comprising one or more TCP connections between a given one of the one or more hosts 101 and the given storage node. In such an arrangement, a host accesses the first controller using the first association, and accesses the second controller using the second association. Such associations are also referred to herein as TCP associations, and may include, for each of at least one Admin queue and a plurality of IO queues, a corresponding TCP connection. Other types of communication links can be used in other embodiments.

In some embodiments, the first controller comprises a first set of IO queues and the second controller comprises a second set of IO queues, for use in processing IO operations for their respective storage pools. Again, each IO queue in a given such set of IO queues may be associated with a separate TCP connection over which a given one of the hosts 101 communicates with the corresponding controller.

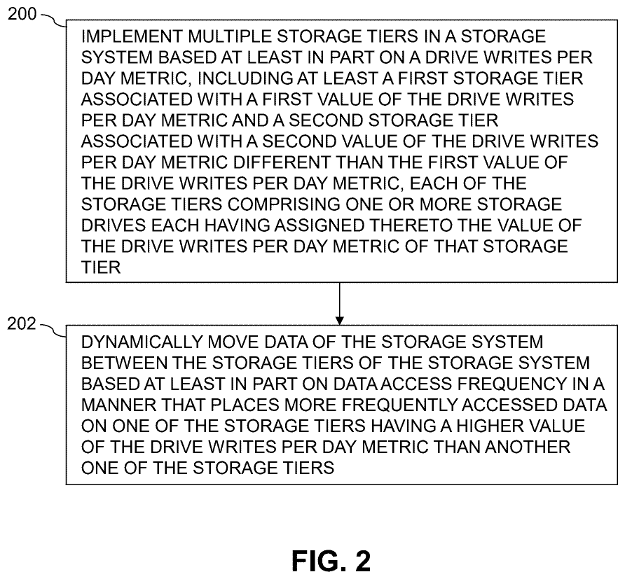

An additional example of an illustrative process for implementing at least some of the above-described functionality for drive writes per day based tiering will be provided below in conjunction with the flow diagram of FIG. 2.

As indicated previously, the storage nodes 105 collectively comprise an example of a distributed storage system. The term “distributed storage system” as used herein is intended to be broadly construed, so as to encompass, for example, scale-out storage systems, clustered storage systems or other types of storage systems distributed over multiple storage nodes, including combinations of multiple storage clusters.

Also, the term “storage volume” as used herein is intended to be broadly construed, and should not be viewed as being limited to any particular format or configuration, such as namespaces or LUNs.

The storage nodes 105 of the example distributed storage system 102 illustrated in FIG. 1 are assumed to be implemented using at least one processing platform, with each such processing platform comprising one or more processing devices, and each such processing device comprising a processor coupled to a memory. Such processing devices can illustratively include particular arrangements of compute, storage and network resources.

The storage nodes 105 may be implemented on respective distinct processing platforms, although numerous other arrangements are possible. At least portions of their associated hosts 101 may be implemented on the same processing platforms as the storage nodes 105 or on separate processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for different subsets of the hosts 101 and the storage nodes 105 to reside in different data centers. Numerous other distributed implementations of the storage nodes 105 and their respective associated sets of hosts 101 are possible.

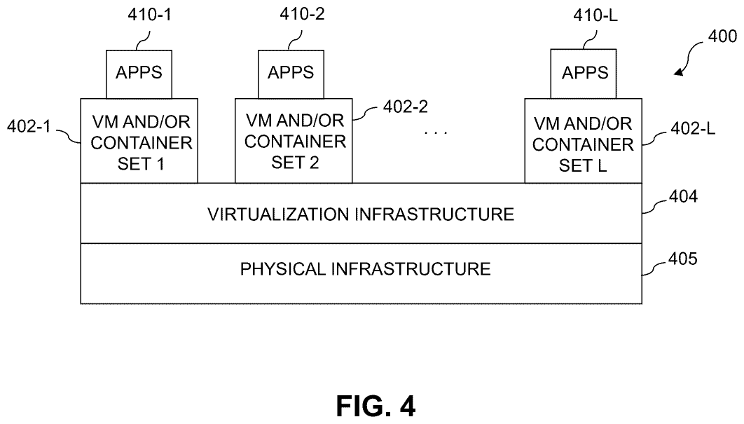

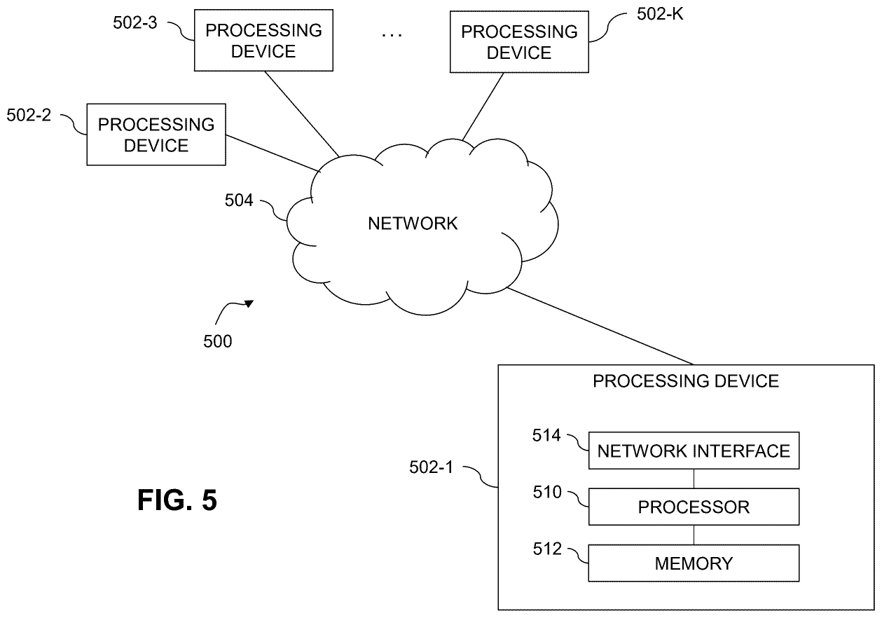

Additional examples of processing platforms utilized to implement storage systems and possibly their associated hosts in illustrative embodiments will be described in more detail below in conjunction with FIGS. 4 and 5.

It is to be appreciated that these and other features of illustrative embodiments are presented by way of example only, and should not be construed as limiting in any way.

The particular features described above in conjunction with FIG. 1 should therefore not be construed as limiting in any way, and a wide variety of other system arrangements implementing drive writes per day based tiering as disclosed herein are possible.

Accordingly, different numbers, types and arrangements of system components such as hosts 101, distributed storage system 102, storage nodes 105, storage devices 106, storage processors 108, system management nodes 110, cluster metadata managers 112, path selection logic 114 and system management database 116 can be used in other embodiments. For example, as mentioned previously, system management functionality of the cluster metadata managers 112 of the system management nodes 110 can be distributed across a subset of the storage nodes 105, instead of being implemented on separate nodes.

It should therefore be understood that the particular sets of modules and other components implemented in a distributed storage system as illustrated in FIG. 1 are presented by way of example only. In other embodiments, only subsets of these components, or additional or alternative sets of components, may be used, and such components may exhibit alternative functionality and configurations.

For example, in other embodiments, certain portions of the functionality for drive writes per day based tiering as disclosed herein can be implemented in one or more hosts, in a storage system, or partially in a host and partially in a storage system. Accordingly, illustrative embodiments are not limited to arrangements in which functionality for drive writes per day based tiering is implemented primarily in storage system or primarily in a particular host or set of hosts, and therefore such embodiments encompass various alternative arrangements, such as, for example, an arrangement in which the functionality is distributed over one or more storage systems and one or more associated hosts, each comprising one or more processing devices, and possibly involving one or more separate management nodes. The term “at least one processing device” as used herein is therefore intended to be broadly construed.

The operation of the information processing system 100 will now be described in further detail with reference to the flow diagram of the illustrative embodiment of FIG. 2, which illustrates a process for drive writes per day based tiering as disclosed herein. This process may be viewed as an example algorithm implemented at least in part by distributed storage system 102 interacting with at least one or more of the hosts 101 and possibly also one or more of the system management nodes 110. These and other algorithms for drive writes per day based tiering as disclosed herein can be implemented using other types and arrangements of system components in other embodiments.

The process illustrated in FIG. 2 includes steps 200 and 202, and in some implementations is performed primarily by a given one of the storage nodes 105 via its corresponding one of the storage processors 108. Similar processes may be performed primarily by respective other ones of the storage nodes 105 via their respective storage processors 108, although it is to be appreciated that numerous other implementations are possible in other embodiments.

In step 200, multiple storage tiers are implemented in a storage system based at least in part on a drive writes per day metric. The drive writes per day metric for a given one of the storage drives in some embodiments is specified in terms of a numerical value that indicates the number of times that a particular capacity of the given storage drive can be written each day for the length of a designated period of time. Other types of drive write per day metrics can be used in other embodiments.

In some embodiments, each of the storage nodes of a given multi-node storage system can separately implement its own set of multiple storage tiers based at least in part on the storage drives of that node and their assigned drive writes per day metric values. It is also possible for the storage tiers to be implemented in a coordinated manner across multiple storage nodes, such that the given multi-node system includes a single set of multiple storage tiers across all of its storage nodes. The term “storage system” as used herein is therefore intended to be broadly construed, so as to encompass, for example, a single storage node that is implemented in a stand-alone manner or as one or more of a plurality of storage nodes of a multi-node storage system.

The storage tiers illustratively include at least a first storage tier associated with a first value of the drive writes per day metric and a second storage tier associated with a second value of the drive writes per day metric different than the first value of the drive writes per day metric, with each of the storage tiers comprising one or more storage drives each having assigned thereto the value of the drive writes per day metric of that storage tier.

In some embodiments, the first value of the drive writes per day metric is set to a value that is greater than a drive writes per day value indicated in a manufacturer specification of the one or more storage drives of the first storage tier.

Additionally or alternatively, the second value of the drive writes per day metric in some embodiments is set to a value that is the same as a drive writes per day value indicated in a manufacturer specification of the storage drives of the second storage tier.

Other embodiments can include other arrangements of storage tiers and associated values of the drive writes per day metric.

For example, in some embodiments, the plurality of storage tiers of the storage system include at least one additional storage tier each comprising one or more storage drives having assigned thereto a value of the drive writes per day metric that is different than the first and second values associated with the respective first and second storage tiers.

As another example, each of the storage drives of a given one of the storage tiers in some embodiments is assigned a same value of the drive writes per day metric that is different than a value of the drive writes per day metric indicated in a manufacturer specification of that storage drive of the given storage tier.

In some embodiments, the one or more storage drives of a given one of the storage tiers are each assigned an increased value of the drive writes per day metric that is determined based at least in part on utilization of less than a full capacity of that storage drive. For example, the increased value of the drive writes per day metric may be determined based at least in part on utilization of only a particular portion of the full capacity, such as 50% of the full capacity, which establishes a corresponding particular increased value of the drive writes per day metric. The increased value of the drive writes per day metric in some embodiments is greater than a drive writes per day value indicated in a manufacturer specification of the one or more storage drives of the given storage tier.

In step 202, data of the storage system is dynamically moved between the storage tiers of the storage system based at least in part on data access frequency in a manner that places more frequently accessed data on one of the storage tiers having a higher value of the drive writes per day metric than another one of the storage tiers.

For example, the storage system in some embodiments is further configured to implement a preference for utilization of a given storage tier having an increased value of the drive writes per day metric in processing incoming write operations.

More particularly, in some embodiments, dynamically moving data of the storage system between the storage tiers of the storage system based at least in part on data access frequency comprises periodically rebalancing data across the storage tiers in a manner that places the most frequently accessed data on the storage tier having a highest value of the drive writes per day metric and places the least frequently accessed data on the storage tier having a lowest value of the drive writes per day metric. Other types of dynamic data movement based on drive writes per day metric values of respective storage tiers can be used.

Steps 200 and 202 are illustratively repeated over time in order to support the functionality for write-per-day based storage tiering as disclosed herein. For example, step 202 may be performed in a continuously repeating loop, so as to provide ongoing dynamic movement of data between storage tiers as data access frequencies change over time. Additionally or alternatively, multiple such processes may operate in parallel with one another in order to provide functionality for drive writes per day based tiering for different storage nodes and their corresponding storage targets.

The steps of the FIG. 2 process are shown in sequential order for clarity and simplicity of illustration only, and certain steps can at least partially overlap with other steps. Additional or alternative steps can be used in other embodiments.

The particular processing operations and other system functionality described in conjunction with the flow diagram of FIG. 2 are therefore presented by way of illustrative example only, and should not be construed as limiting the scope of the disclosure in any way. Alternative embodiments can use other types of processing operations for implementing drive writes per day based tiering in a system comprising one or more hosts and a storage system. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for respective different storage nodes.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

One or more hosts and/or one or more storage nodes can be implemented as part of what is more generally referred to herein as a processing platform comprising one or more processing devices each comprising a processor coupled to a memory.

A given such processing device in some embodiments may correspond to one or more virtual machines or other types of virtualization infrastructure such as Docker containers or Linux containers (LXCs). Hosts, storage processors and other system components may be implemented at least in part using processing devices of such processing platforms. For example, respective path selection logic instances and other related logic instances of the hosts can be implemented in respective containers running on respective ones of the processing devices of a processing platform.

Referring now to FIG. 3, an additional example of an information processing system 300 implementing functionality for drive writes per day based tiering is shown. The system 300 comprises a plurality of host devices 301, denoted as Host 1, Host 2, Host 3, Host 4, Host 5, . . . . Host M, and at least one storage cluster comprising a first storage node 305-1 and other storage nodes 305-2 through 305-N. The system 300 is assumed to be a software-defined storage system, also referred to herein as an SDS system, and the storage targets in this embodiment illustratively comprise respective storage data targets (SDTs) as illustrated. The host devices 301 and the storage nodes 305 communicate with one another over a TCP/IP network 304.

Also coupled to the TCP/IP network 304 is a cluster metadata manager 312 of the cluster of storage nodes 305. The storage nodes 305 collectively comprise a distributed storage system in which each of a plurality of storage targets implemented on respective ones of the storage nodes 305 shared by the host devices 301. Other embodiments can include additional clusters, host devices, storage targets, cluster metadata managers and/or other processing device based system components.

It is assumed that applications execute on the host devices 301 and generate IO operations that are delivered over the TCP/IP network 304 to particular SDTs of the storage nodes 305. Each of the SDTs is configured to operate as a host-storage interface to handle IO operations received in the SDT from the host devices 301. Accordingly, the IO processing loads of the respective SDTs of the storage nodes 305 include processing of IO operations received in those respective SDTs from the host devices 301.

In some embodiments, the storage nodes 305 are configured at least in part as respective clusters of PowerFlex™ software-defined storage nodes from Dell Technologies, suitably modified as disclosed herein to implement functionality for drive writes per day based tiering, although it is to be appreciated that other types of storage nodes can be used in other embodiments.

The storage nodes 305 collectively provide a distributed storage system based on the NVMe access protocol. The storage targets in this embodiment comprise multiple NVMe targets, illustratively implemented as respective SDTs, each providing a different storage system interface. Application servers or other host devices can connect to several of the NVMe targets for IO load balancing, bandwidth utilization and congestion avoidance, illustratively utilizing path selection algorithms implemented in MPIO drivers of the type noted above. Moreover, one or more of the SDTs may additionally be configured for use as data mobility interfaces to handle IO operations generated as part of one or more data services.

In some embodiments, in order to utilize NVMe-OF technology, SDTs are configured on respective storage nodes 305 of the system 300, which as indicated above comprises software-defined storage. A given such SDT generally acts as a frontend for its corresponding storage node, providing a host-storage interface to backend storage on that node, and handles functionality such as IO processing and connection discovery services for NVMe hosts configured within the SDS system. Some SDTs can additionally or alternatively be utilized in other use cases such as data mobility (e.g., replication, migration, data copy, etc.), where SDTs in a source cluster of the SDS system make IO connections to SDTs in a remote cluster, also referred to as a target cluster of the SDS system, and use those IO connections to transfer data from the source cluster to the target cluster in the SDS system. An SDT can therefore have multiple interfaces and each interface can take one or multiple roles (e.g., host-storage interface and data mobility interface) based on user configuration.

The storage node 305-1 includes, as at least part of its storage frontend, an SDT 320. The SDT 320 comprises a plurality of logic components including at least drive writes per day based storage tier configuration logic 321 and inter-tier data movement control logic 322. The storage node 305-1 further includes, as at least part of its storage backend, a storage data server 324 and local storage drives 326. The storage data server 324 illustratively serves as an interface between the SDT 320 and the local storage drives 326.

The drive writes per day based storage tier configuration logic 321 is illustratively configured to implement a plurality of storage tiers in the storage node 305-1 based at least in part on a drive writes per day metric, including at least a first storage tier associated with a first value of the drive writes per day metric and a second storage tier associated with a second value of the drive writes per day metric different than the first value of the drive writes per day metric. Each of the storage tiers comprises one or more of the local storage drives 326. The local storage drives 326 are arranged in the multiple storage tiers in accordance with different values of the drive writes per day metric, with each such storage device being assigned the value of the drive writes per day metric of its corresponding storage tier. Again, terms such as “assigned” in this and other similar contexts herein are intended to be broadly construed, so as to encompass various arrangements for designating and maintaining particular drive writes per day values for respective ones of the storage drives, in order to establish a drive writes per day tiering arrangement as disclosed herein, where such values for at least some of the storage drives differ from drive writes per day values that are indicated in manufacturer specifications for those storage drives. As mentioned previously, the values in some embodiments may indicate or be otherwise associated with a range of such values associated with a given storage tier in a drive writes per day based storage tiering arrangement.

The inter-tier data movement control logic 322 is illustratively configured to dynamically move data of the storage system between the storage tiers of the storage system based at least in part on data access frequency in a manner that places more frequently accessed data on one of the storage tiers having a higher value of the drive writes per day metric than another of the storage tiers, as described in more detail elsewhere herein.

It is assumed that each of the other storage nodes 305-2 through 305-N of the system 300 is also configured to include at least one SDT 320, at least one storage data server 324 and at least one set of local storage drives 326, arranged in a manner similar to that illustrated for the storage node 305-1 in the figure.

In some embodiments, the cluster metadata manager 312 may be involved in at least portions of the drive writes per day based storage tiering functionality of the SDT 320. For example, the drive writes per day based storage tier configuration logic 321 in some embodiments can be implemented at least in part in the cluster metadata manager 312, or in another component of system 300, rather than in the SDT 320 as illustrated in the figure. Other SDT components such as inter-tier data movement control logic 322 can similarly in other embodiments be implemented at least in part outside of the SDT 320, such as in the cluster metadata manager 312 or in another component of system 300.

As indicated previously, illustrative embodiments provide significant advantages over conventional practice. For example, these embodiments provide substantially reduced storage system cost, as well as optimized storage drive life based on usage, and no reduction in write performance based on utilization of lower-cost storage drives.

It is to be appreciated that the particular advantages noted above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

For example, it is to be appreciated that references in the above description to storage systems comprising storage nodes each having multiple storage tiers are presented by way of example only, and other embodiments can utilize numerous other types and arrangements of drive writes per day based storage tiering, in a wide variety of different types and arrangements of storage systems.

Multi-pathing portions of the example techniques described above may be performed by a given MPIO driver on a corresponding host device, and similarly by other MPIO drivers on respective other host devices. Such MPIO drivers illustratively form a multi-path layer comprising multi-pathing software of the host devices. Other types of host drivers can be used in other embodiments.

Although particular software-defined storage system configurations are described in conjunction with some embodiments above, the disclosed techniques can be adapted in a straightforward manner for use in a wide variety of other types of storage systems. Accordingly, the disclosed techniques should not be viewed as being restricted in any way to particular storage systems, such as PowerFlex™ storage systems.

Also, storage access protocols other than SCSI and/or NVMe access protocols can be used in other embodiments.

Furthermore, the particular system configuration as shown in FIG. 3 is presented by way of illustrative example only, and should not be viewed as limiting in any way. A wide variety of different alternative arrangements of host devices, storage node clusters and metadata managers can be used in other embodiments.

For example, in some embodiments, an information processing system comprises host-side elements that include application processes, path selection logic and IO processing logic, and storage-side elements that include multiple storage targets and IO processing logic. The path selection logic is configured to operate in conjunction with the host-side IO processing logic, the multiple storage targets and the storage-side IO processing logic, and possibly additional components such as one or more cluster metadata managers of one or more system management nodes, to implement functionality for drive writes per day based tiering in the system in the manner disclosed herein. There may be separate instances of one or more such elements associated with each of a plurality of system components such as hosts and storage arrays of the system. For example, different instances of the path selection logic and host-side IO processing logic are illustratively implemented within or otherwise in association with respective ones of a plurality of MPIO drivers of respective hosts. In other embodiments, the host-side IO processing logic can be implemented at least in part within the path selection logic. Numerous other arrangements are possible.

The system in some embodiments may be configured in accordance with a layered system architecture that illustratively includes a host processor layer, an MPIO layer, a host port layer, a switch fabric layer, a storage array port layer and a storage array processor layer. The host processor layer, the MPIO layer and the host port layer are associated with one or more hosts, the switch fabric layer is associated with one or more SANs or other types of networks, and the storage array port layer and storage array processor layer are associated with one or more storage arrays. A given such storage array illustratively comprises a software-defined storage system or other type of distributed storage system comprising a plurality of storage nodes, and may be one of a plurality of clusters of the distributed storage system. In addition, as indicated above, one or more cluster metadata managers of one or more system management nodes may also be associated with such clusters, and configured to implement at least portions of the disclosed functionality for drive writes per day based tiering.

In a manner similar to that described elsewhere herein, one or more storage arrays of the system are each configured to implement drive writes per day tiering functionality. For example, the system in such an embodiment illustratively implements functionality for drive writes per day based tiering utilizing one or more MPIO drivers of the MPIO layer, and associated instances of path selection logic and host-side IO processing logic, as well as the multiple storage targets and the storage-side IO processing logic, possibly with one or more cluster metadata managers associated with one or more management nodes. It should be noted in this regard that in some embodiments, functionality of a cluster metadata manager may be implemented at least in part within one or more storage nodes of a given storage cluster, instead of within one or more management nodes.

Although various types of commands and log pages are used in illustrative embodiments herein, other types of commands and log pages can be used in other embodiments. For example, various types of log sense, mode sense and/or other “read-like” commands, possibly including one or more commands of a standard storage access protocol such as the above-noted NVMe and SCSI access protocols, can be used in other embodiments.

These and other features of illustrative embodiments disclosed herein are examples only, and should not be construed as limiting in any way. Other types of drive writes per day based tiering can be used in other embodiments, and the term “drive writes per day based tiering” as used herein is intended to be broadly construed.

Illustrative embodiments of processing platforms utilized to implement hosts and distributed storage systems with functionality for drive writes per day based tiering will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. Such implementations can provide functionality for drive writes per day based tiering in a distributed storage system of the type described above using one or more processes running on a given one of the VMs. For example, each of the VMs can include logic instances and/or other components for implementing functionality associated with drive writes per day based tiering in the system 100.

A hypervisor platform may be used to implement a hypervisor within the virtualization infrastructure 404. Such a hypervisor platform may comprise an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system. Such implementations can also provide functionality for drive writes per day based tiering in a distributed storage system of the type described above. For example, a container host supporting multiple containers of one or more container sets can include logic instances and/or other components for implementing functionality associated with drive writes per day based tiering in the system 100.

As is apparent from the above, one or more of the processing devices or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphics processing unit (GPU), a neural processing unit (NPU), a data processing unit (DPU) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise various arrangements of converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for drive writes per day based tiering provided by one or more components of a storage system as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, hosts, storage systems, storage nodes, storage targets, storage tiers, logic instances and other components relating to drive writes per day based tiering as described herein. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to implement a plurality of storage tiers in a storage system based at least in part on a drive writes per day metric, including at least a first storage tier associated with a first value of the drive writes per day metric and a second storage tier associated with a second value of the drive writes per day metric different than the first value of the drive writes per day metric, each of the storage tiers comprising one or more storage drives each having assigned thereto the value of the drive writes per day metric of that storage tier; and
to dynamically move data of the storage system between the storage tiers of the storage system based at least in part on data access frequency in a manner that places more frequently accessed data on one of the storage tiers having a higher value of the drive writes per day metric than another of the storage tiers.

2. The apparatus of claim 1 wherein the storage system comprises a distributed storage system with a plurality of storage nodes and wherein each of one or more of the storage nodes of the distributed storage system implements the plurality of storage tiers based at least in part on the drive writes per day metric.

3. The apparatus of claim 1 wherein the drive writes per day metric for a given one of the storage drives is specified in terms of a numerical value that indicates the number of times that a particular capacity of the given storage drive can be written each day for the length of a designated period of time.

4. The apparatus of claim 1 wherein the first value of the drive writes per day metric is set to a value that is greater than a drive writes per day value indicated in a manufacturer specification of the one or more storage drives of the first storage tier.

5. The apparatus of claim 1 wherein the second value of the drive writes per day metric is set to a value that is the same as a drive writes per day value indicated in a manufacturer specification of the storage drives of the second storage tier.

6. The apparatus of claim 1 wherein the plurality of storage tiers of the storage system include at least one additional storage tier each comprising one or more storage drives having assigned thereto a value of the drive writes per day metric that is different than the first and second values associated with the respective first and second storage tiers.

7. The apparatus of claim 1 wherein the one or more storage drives of a given one of the storage tiers are each assigned an increased value of the drive writes per day metric that is determined based at least in part on utilization of less than a full capacity of that storage drive.

8. The apparatus of claim 7 wherein the increased value of the drive writes per day metric is greater than a drive writes per day value indicated in a manufacturer specification of the one or more storage drives of the given storage tier.

9. The apparatus of claim 7 wherein the at least one processing device is further configured to implement a preference for utilization of the given storage tier having the increased value of the drive writes per day metric in processing incoming write operations.

10. The apparatus of claim 1 wherein different assigned values of the drive writes per day metric for different ones of the storage tiers are determined based at least in part on respective different write amplification factors.

11. The apparatus of claim 1 wherein assignment of different values of the drive writes per day metric for different ones of the storage tiers is controlled at least in part by an operating system tool of the storage system.

12. The apparatus of claim 1 wherein dynamically moving data of the storage system between the storage tiers of the storage system based at least in part on data access frequency comprises periodically rebalancing data across the storage tiers in a manner that places the most frequently accessed data on the storage tier having a highest value of the drive writes per day metric and places the least frequently accessed data on the storage tier having a lowest value of the drive writes per day metric.

13. The apparatus of claim 1 wherein the at least one processing device is further configured to associate tiering information with respective storage objects of the storage system, the tiering information including a tier level indicator and its corresponding drive writes per day value, a given such storage object being associated with one or more data blocks of the storage system.

14. The apparatus of claim 1 wherein each of the storage drives of a given one of the storage tiers is assigned a same value of the drive writes per day metric that is different than a value of the drive writes per day metric indicated in a manufacturer specification of that storage drive of the given storage tier.

15. A computer program product comprising a non-transitory processor-readable storage medium having stored therein program code of one or more software programs, wherein the program code when executed by at least one processing device comprising a processor coupled to a memory, causes the at least one processing device:
to implement a plurality of storage tiers in a storage system based at least in part on a drive writes per day metric, including at least a first storage tier associated with a first value of the drive writes per day metric and a second storage tier associated with a second value of the drive writes per day metric different than the first value of the drive writes per day metric, each of the storage tiers comprising one or more storage drives each having assigned thereto the value of the drive writes per day metric of that storage tier; and
to dynamically move data of the storage system between the storage tiers of the storage system based at least in part on data access frequency in a manner that places more frequently accessed data on one of the storage tiers having a higher value of the drive writes per day metric than another of the storage tiers.

16. The computer program product of claim 15 wherein the one or more storage drives of a given one of the storage tiers are each assigned an increased value of the drive writes per day metric that is determined based at least in part on utilization of less than a full capacity of that storage drive.

17. The computer program product of claim 15 wherein dynamically moving data of the storage system between the storage tiers of the storage system based at least in part on data access frequency comprises periodically rebalancing data across the storage tiers in a manner that places the most frequently accessed data on the storage tier having a highest value of the drive writes per day metric and places the least frequently accessed data on the storage tier having a lowest value of the drive writes per day metric.

18. A method comprising:
implementing a plurality of storage tiers in a storage system based at least in part on a drive writes per day metric, including at least a first storage tier associated with a first value of the drive writes per day metric and a second storage tier associated with a second value of the drive writes per day metric different than the first value of the drive writes per day metric, each of the storage tiers comprising one or more storage drives each having assigned thereto the value of the drive writes per day metric of that storage tier; and
dynamically moving data of the storage system between the storage tiers of the storage system based at least in part on data access frequency in a manner that places more frequently accessed data on one of the storage tiers having a higher value of the drive writes per day metric than another of the storage tiers;
wherein the method is performed by at least one processing device comprising a processor coupled to a memory.

19. The method of claim 18 wherein the one or more storage drives of a given one of the storage tiers are each assigned an increased value of the drive writes per day metric that is determined based at least in part on utilization of less than a full capacity of that storage drive.

20. The method of claim 18 wherein dynamically moving data of the storage system between the storage tiers of the storage system based at least in part on data access frequency comprises periodically rebalancing data across the storage tiers in a manner that places the most frequently accessed data on the storage tier having a highest value of the drive writes per day metric and places the least frequently accessed data on the storage tier having a lowest value of the drive writes per day metric.
